(19) United States
(12) Patent Application Publication
(10) Pub. No.: US 2006/0054721 A1
(43) Pub. Date: Mar. 16, 2006

(54) Connection assembly for high-pressure pipes in vehicle air conditioning units

(76) Inventor: Dominik Prinz, Elsdorf (DE)

Correspondence Address: VISTEON, C/O BRINKS HOFER GILSON & LIONE, PO BOX 10395, CHICAGO, IL, 60610, US

(21) Appl. No.: 11/224,381

(22) Filed: Sep. 12, 2005

(30) Foreign Application Priority Data
Sep. 10, 2004 (DE) 10 2004 044 636.9

(51) Int. Cl. A62C 31/02; B05B 1/04; B05B 1/00

(52) U.S. Cl. 239/589; 239/593; 239/594

(57) ABSTRACT

A connection assembly for the connections of high-pressure pipes in vehicle air conditioning units. The connection assembly includes a connection block having a through channel with a narrowing portion defined by at least one step. A nozzle is located in the through channel of the connection block and the nozzle includes a tapering portion with an exterior surface having at least one step. The narrowing and tapering portions generally correspond with each other and cooperate to define stepped circular gap. A high-pressure pipe extends through the channel outflow region and has a cold deformation end region located in the stepped circular gap, which was forced thereinto upon the nozzle being pressed into the connection block. The hardness of the nozzle is greater than the hardness of the pipe, and the coefficient of thermal expansion of the nozzle is less than the coefficient of thermal expansion of the pipe.

### BACKGROUND OF THE INVENTION

1. Field of the Invention

The invention generally relates to a connection assembly and, more specifically to the connections of high-pressure pipes in vehicle air conditioning units.

2. Related Technology

The traditional methods to establish connections, such as brazing and welding, weaken the mechanical properties of pipe connection elements in air conditioning units. The high temperatures and pressures required when the coolant (refrigerant) R744 is used make it necessary to use stronger aluminum alloys for the high-pressure pipes. These alloys are more resistant against heat treatment compared to the materials used at present with the coolant (refrigerant) R134a. The brazing/welding process reduces the hardness of the sealing surface, which is less loadable due to the extreme operating conditions and, therefore, can easily be damaged. In particular, the high operating system temperatures in the heat exchangers lessen the strength and hardness and may cause yielding of the aluminum material. Cooling to low environment temperatures can also cause defects and leaks due to thermal material contraction effects.

In GB 2 281 947 A, a connection assembly is described, especially for pressure pipes, which includes at least two pipe fittings. Each of the pipe fittings is arranged in the end region of a pipe and is provided with an inner annular slot in order to withstand breaking forces. Each pipe fitting is also provided, on the circumference of its inner surface, with grooves running parallel to the axis of the fitting. The grooves can be located between the annular slot, or annular slots, and the free end region of the fitting. In the assembled state, the pipe wall is impressed, tooth-like, into the grooves of the inner surface.

A connection assembly using press fittings for thin-walled tubes is described in EP 0 378 882 B1. This connection assembly is intended to connect thin-walled tubes of titanium or a titanium alloy to each other. Press fittings are provided with a bead-shaped end that accepts a seal ring. The tubes are connected to the press fitting in cold state, by form and force closing using a pressing tool. At least the region of the press fitting that contains the seal ring is pressed to the tube, whereby the inner diameter of the tube is reduced in the region of pressing. A hexagonal cross-sectional configuration is formed in the immediate vicinity of the bead-shaped end of the press fitting.

U.S. Pat. No. 5,405,176 describes a mechanical high-pressure sealing element for a high-pressure agent or a hydraulic system where, between the outer wall surface of a hard metal tube and an inner wall surface of a mechanical hard metal connection element, a very thin light metal layer is arranged, either by application to the outer wall surface or to the inner wall surface, before the hard metal connection element is pulled over the tube by upsetting. The thickness of a thin light metal layer is independent of the sizes of the tube and the hard metal connection element. Many metals, and alloys of those metals, have the required softness, including silver, gold, nickel, tin, platinum, indium, rhodium, cadmium. The thin light metal layer has a thickness of approximately 0.0025 mm.

In EP 0 390 047 A1 two pipe end regions, which are insertable into each other, are connected to each other (or to pipe or flexible hose connection parts) by a diameter-reducing cold forming process. At least one of the pipe end regions is equipped with a connection piece that, prior to the diameter-reducing cold forming, is provided with an inner diameter larger than the common inner diameter final measure of both pipe end regions. The diameter-reducing cold forming is carried out until connection of both pipe end regions to each other has been reached.

A connection device for the generation of a permanent pipe connection is described in U.S. Pat. No. 4,598,938. In this pipe connection, the pipe end region is pressed or cold formed in successive zones, using an axially movable press ring, to build a form closed tight connection with a pipe fitting nozzle inserted into the pipe end region. A sleeve, movable onto the pipe end region, is provided with an annular outer bead and is deformed when the press ring is pressed on the sleeve that the sleeve material in the bead zone is forced in an inward radial direction, whereby the pipe end region and nozzle are provided with an annular inner indentation. In addition, at its rear end the press ring has an annular inner bead that simultaneously displaces the sleeve material, at the rear sleeve edge, in and inward radial direction so that further pressing is achieved at the end of the nozzle. In this way also the gap between pipe and nozzle is closed.

Another connector for the pipe end regions of heat exchangers is described in EP 0 678 695 A2. This connector is made of deformable material and connection is made by cold forming the connector, a pipe end region having a first cylindrical connection surface and a corresponding second surface of an element. The connector includes an elastic ring places between the surfaces (ensuring fluid-tightness of the connection) and a means to prevent axial sliding-out of the connected element from the first cylindrical connection surface.

Common to all of the above-mentioned connection assemblies is that they do not compensate for the effects of wide temperature and pressure variations on the seals when high-pressure refrigerants are used in the heat exchangers. This makes them susceptible to leaking in the connection regions.

Therefore, the present invention aims at providing a connection assembly for establishing the connections of high-pressure pipes in vehicle air conditioning units where the connections are configured to ensure improved. With this invention, an intention is to compensate for the influence of the material deformation, material expansion and material contraction on sealing due to wider temperature variations. In addition, the invention is intended to allow a high-pressure pipe and a sealing nozzle to be connected quickly and easily.

### SUMMARY OF THE INVENTION

A connection assembly according to the principles of the present invention generally includes a connection block and a hard nozzle. The connection block includes a through channel that narrows, generally conically in steps, from its channel inflow region to its channel outflow region. The nozzle also tapers conically in steps and, between the through channel and the hard nozzle, a conical stepped circular gap is provided. The hard nozzle is inserted into the connection block from the side of the channel inflow region and a high-pressure pipe is insertable into the connection block from the side of the channel outflow region. By means of pressing of the hard nozzle into the high-pressure pipe, the stepped circular gap is filled with a cold deformation zone of the high-pressure pipe end region and the high-pressure pipe end region is pressed to form step-like partial zones. The nozzle is made of a material that has a hardness that is greater than the hardness of the material of the high-pressure pipe, and has a coefficient of thermal expansion that is less than the coefficient thermal expansion of the material of the high-pressure pipe. The material of the nozzle preferably has a hardness at least 50% higher than the hardness of the connection block material and the high-pressure pipe material.

After pressing with the high-pressure pipe end region, the hard metal nozzle forms an axially directed sealing surface with the high-pressure pipe and a radially directed sealing region with the connection block.

The channel inflow region also includes an annular groove formed therein. The nozzle can in turn be provided with a flange corresponding with the annular groove. When the hard metal nozzle is pressed into the high-pressure pipe, an insertion limiting or form-closing stop is formed between the flange and the annular groove.

The nozzle has at least one step in its tapering and the through channel has at least one step in its narrowing. The steps of the taperings of the nozzle and the steps of the narrowings of the through channel are located largely opposite to each other, separated by an intermediately positioned cold deformation zone, that is assigned to the annular gap, of the pressed high-pressure pipe. Preferably the taperings of the nozzle occur to one side of the optionally provided flange and, correspondingly, the narrowings of the channel occur to one side of the inflow annular groove.

The configuration of the nozzle and the cold deformation zone of the pipe end region existing in the annular gap is such that compensation for thermal deformation effects on the connection assembly is achieved.

According to the invention, the properties of the hard metal nozzle and the cold deformation zone are given in the operating range between 40° C. and 180° C.

The nozzle has an alternating succession of reduced diameter cylindrical outer surfaces and tapering truncated cone outer surfaces. Additionally, the nozzle end face has a larger outer diameter than the inner diameter of the high-pressure pipe located in the channel outflow region. The inner diameter of the high-pressure pipe is largely equivalent to the inner diameter of the hard metal nozzle.

The through channel of the connection block similarly has an alternating succession of reduced diameter cylindrical inner surfaces and tapering truncated cone inner surfaces.

The cylindrical surfaces and truncated surfaces of the nozzle and those of the through channel, which are opposite to each other, have different diameters so that between the nozzle and the connection block there is a continuous and generally stepped conical circular gap formed from the respective stepped conical taperings or narrowings.

The cold deformation zone material pressed into the circular gap has an inner replica of the surface of the nozzle and an outer replica of the surface of the through channel.

Preferably the flange of the hard metal nozzle can fittingly bear against the annular groove at the side of the channel inflow region.

According to the invention, a method for establishing connections of high-pressure pipes in vehicle air conditioning units includes the following steps: providing a connection block with a through channel having stepped narrowings; positioning a high-pressure pipe within the stepped narrowing; inserting a hard metal nozzle having stepped tapering into the connection block; pressing, with the nozzle end face leading, the hard metal nozzle into the high-pressure pipe; cold-deformingly an end region of the pipe into a circular gap defined between the hard metal nozzle and the through channel; whereby the high-pressure pipe end region forms a radially enlarged cold deformation zone between the connection block and the hard metal nozzle and the cold deformation zone fills the circular gap and creates temperature-dependent direction-related sealing connections between the hard metal nozzle, the high-pressure pipe and the connection block.

With the configuration of the present invention, the cold deformation zone is established such that for temperatures T rising over a predefined standard temperature T₀, T>T₀, the axial sealing pressure, P_{ax,0}, parallel to the pipe axis at the axial sealing surface is increased and the accompanying radial sealing pressure, P_{rad,0}, is reduced. For temperatures T falling under the predefined standard temperature T₀, T<T₀, the radial sealing pressure, P_{rad,0}, directed vertical to the pipe axis increases and the axial sealing pressure, P_{ax,0}, at the axial sealing surface is reduced.

The invention makes possible that the combination of an aluminum body with a high-hardness sealing connection reduces creeping due to increased resistance of the sealing surface against damage.

The sealing nozzle, with its high hardness and mechanical resistance against temperature influence, is provided to enhance the resistance of a sealing surface from mechanical damages and temperature influences on the hardness, strength, particularly creeping and thermal expansion/contraction effects.

### BRIEF DESCRIPTION OF THE DRAWINGS

Further characteristics and advantages of the invention will become readily apparent to persons skilled in the art after a review of the following detailed description of preferred embodiments with reference to the accompanying drawings of which shows:

FIG. 1 is a perspective representation of a connection assembly according to the invention after pressing, and including a connection block, a hard metal nozzle and a high-pressure pipe made of aluminum;

FIG. 2a is a cross-sectional view of the nozzle;

FIG. 2b is a cross-sectional view of the connection block;

FIG. 3 is a cross-sectional view of the connection assembly with the connection block having the high-pressure pipe and the hard metal nozzle inserted therein;

FIG. 4a is a cross-sectional view of a cold deformation zone for where the temperature T is equivalent to a standard temperature T₀ at which the axial sealing pressure P_{ax,0} and the radial sealing pressure P_{rad,0} exist and pressing is executed;

FIG. 4b is a cross-sectional view of the cold deformation zone for a higher refrigerant temperature T, T>T₀, with increased axial sealing pressure P_{as,0}; and

FIG. 4c is a cross-sectional view of the cold deformation zone for a lower temperature T, T<T₀, with increased radial sealing pressure P_{rad,0}.

### DETAILED DESCRIPTION

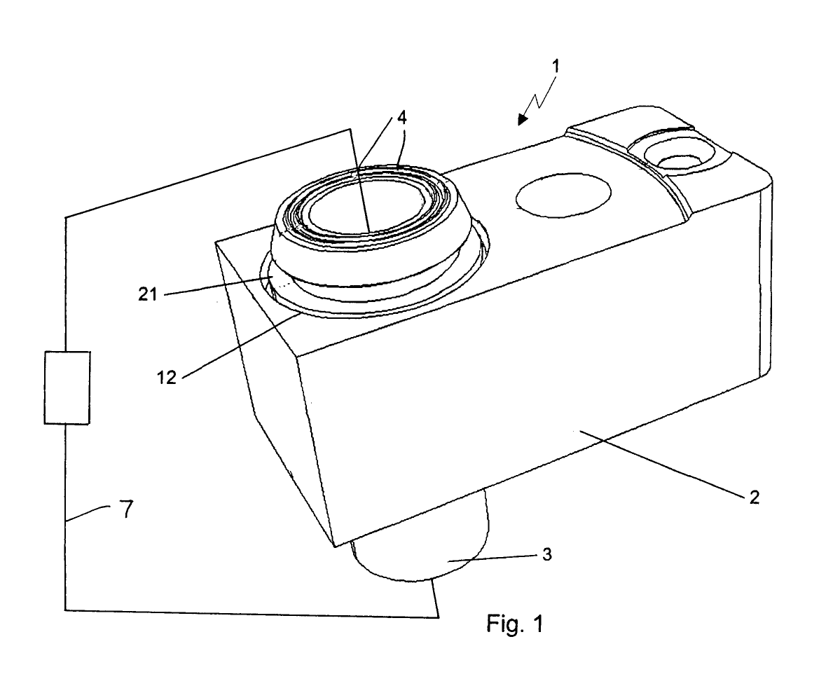

Referring now to the drawings, FIG. 1 generally illustrates a connection assembly 1 for forming a connection at a high-pressure pipe 3 in a vehicle air conditioning unit or circuit 7. The assembly 1 includes a connection block 2 with a through channel 16, in which steps conically narrow the channel 16 from the channel inflow region 20 to the channel outflow region 22. An annular groove 12 is also formed in the channel inflow region 20.

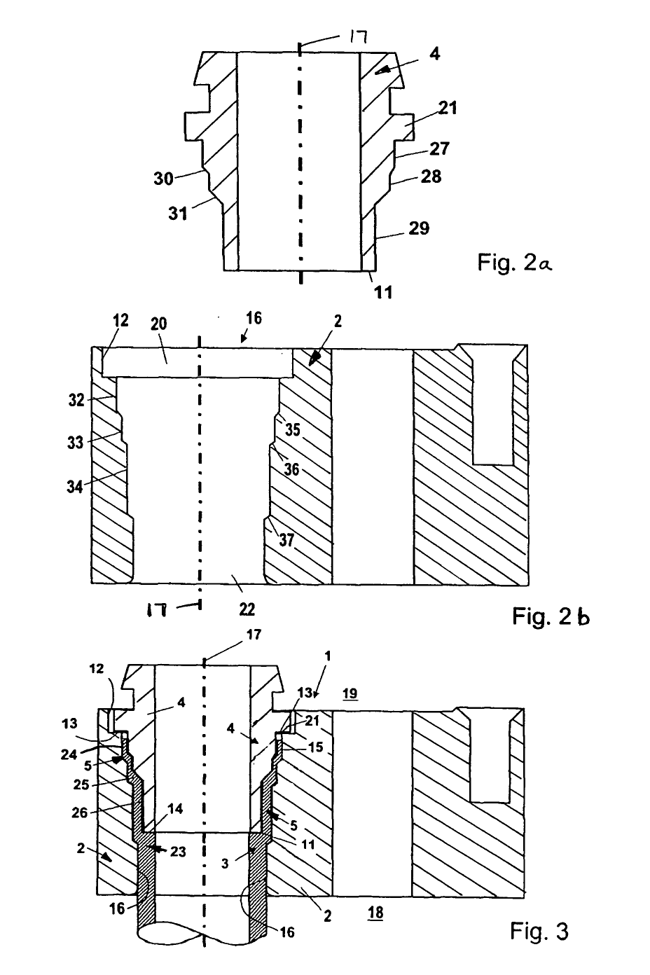

The assembly 1 also includes a hard metal nozzle 4 that is conically tapered in steps. The hard metal nozzle 4, as shown in FIG. 2a, is provided with a flange 21 and, to one side thereof, with an alternating succession of reduced diameter cylindrical outer surfaces 27, 28, 29 and tapering truncated cone outer surface 30, 31. Additionally, the nozzle 4 has an end face 11 that is larger in its outer diameter than the inner diameter of the high-pressure pipe 3 inserted into the channel outflow region 22.

As seen in FIG. 2b, the through channel 16 of the connection block 2 has, starting with the annular groove 12 and proceeding in the direction of the channel outflow region 22, an alternating succession of reduced diameter cylindrical inner surfaces 32, 33, 34 and tapering truncated cone inner surfaces 35, 36, 37. The cylindrical surfaces 27-32; 28-33; 29-34 and truncated cone surfaces 30-35; 31-36, which are generally opposite to each other, have different diameters so that there is formed between them a continuous stepped conical circular gap 5. The circular gap 5 is completed by the distance between the nozzle end face 11 and the radially tapering truncated cone inner surface 37.

By means of pressing of the hard metal nozzle 4 into the high-pressure pipe 3, the stepped circular gap 5 of the through channel 16 is filled by a cold deformation zone of an end region 23 of the high-pressure pipe 3. Preferably, the hard metal nozzle 4 is made of a material that is of a hardness greater than the hardness of the material of the high-pressure pipe 3, and that has a coefficient of thermal expansion that is less than the coefficient of thermal expansion of the material of the high-pressure pipe 3.

During assembly, the hard metal nozzle 4 is pressed into the end region 23 of the pipe 3. As shown in FIG. 3, the hard metal nozzle 4 deforms the end of the high-pressure pipe 3 in step-like partial zones 24, 25, 26 and, after pressing, the end region 23 forms an axial sealing surface 14 with the nozzle and a radially directed sealing region 15, which can extend over several partial zones, with the connection block 2.

The hard metal nozzle 4, is optionally, provided with a flange 21 that corresponds with the annular groove 12. The hard metal nozzle 4 tapers conically in its steps only to one side of the flange 21. When the metal nozzle 4 is pressed into the high-pressure pipe 3, preferably an insertion limiting or form-closing stop 13, between the flange 21 and the annular groove 12, is formed.

The hard metal nozzle 4 and the material of the cold deformation zone of the pipe end region 23 located in the annular gap 5, are configured such that compensation of thermal deformation effects on the connection assembly is achieved. According to the invention, the above properties of the hard metal nozzle 4 and of the cold deformation zone of the end region 23 are provided and maintained in an operating temperature range between −40° C. and 180° C.

The material of the hard metal nozzle 4 has a hardness at least 50% higher than the hardness of the material of the connection block 2 and the material of the high-pressure pipe 3. Preferably the material of the high-pressure pipe 3 is aluminum, or an aluminum alloy.

The material of cold deformation zone of the end region 23 is correspondingly equivalent to the circular gap 5 and has an inner replica surface corresponding to hard metal nozzle 4 and an outer replica surface corresponding to the through channel 16, starting from the above stop 13 of flange 21 and annular groove 12.

The method according to the invention for the establishment of connections of the high-pressure pipe 3 in vehicle air conditioning units, is as follows: providing a connection block 2 with a through channel 16 having stepped narrowings; positioning a high-pressure pipe within the stepped narrowing; inserting a hard metal nozzle 4 having stepped tapering into the connection block 2; pressing, with the nozzle end face 11 leading, the hard metal nozzle 4 into the high-pressure pipe 3; cold-deformingly an end region of the pipe 3 into a circular gap 5 defined between the hard metal nozzle 4 and the through channel 16; whereby the high-pressure pipe end region 23 forms a radially enlarged cold deformation zone 5 between the connection block 2 and the hard metal nozzle 4 and the cold deformation zone 5 fills the circular gap and creates temperature-dependent direction-related sealing connections between the hard metal nozzle 4, the high-pressure pipe 3 and the connection block 2.

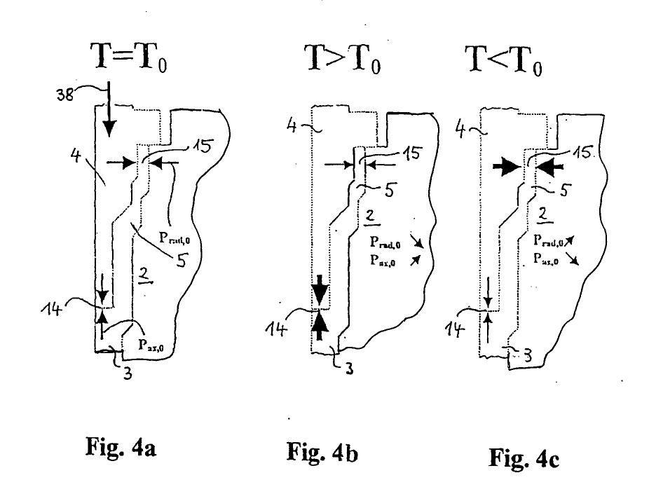

As shown in FIG. 4a, pressing is performed in an axial pressing direction 38 at a predefined standard temperature T₀ with T=T₀, in order to create equal sealing pressure conditions at the sealing surfaces 14 and 15 of the cold deformation zone.

As shown in FIG. 4b, in the cold deformation zone filling the circular gap 5, the axial sealing pressure P_{ax,0} parallel to the pipe axis 17 (shown in FIGS. 2A, 2B and 3) at the axial sealing surface 14 increases for temperatures T rising over the predefined standard temperature T₀, T>T₀, and the accompanying radial sealing pressure, P_{rad,0}, in the radial sealing region 15 is reduced.

It is shown in FIG. 4c that for temperatures T falling below the predefined standard temperature T₀, T<T₀, the radial sealing pressure, P_{rad,0}, directed perpendicular to the pipe axis 17 increases in the radial sealing region 15 and the axial sealing pressure P_{ax,0} at the axial sealing surface 14 is reduced.

The connection assembly 1, without the inserted high-pressure pipe 3, can contain a preferably cuboid-shaped aluminium connection block 2 with a through channel 16 provided with an annular groove 12 and a tapering hard metal nozzle 4 (optionally provided with collar-like flange 21), both with successive cylindrical surfaces of reduced diameters whereby between the cylindrical surfaces there are tapering truncated cone-like surfaces. The flange 21 of the hard metal nozzle 4 can fittingly and sealingly bear against the annular groove 12, with or without stop 13, of the through channel 16. Between the surfaces of the hard metal nozzle 4 and the through channel 16, a stepped conical circular gap 5 is provided. This gap 5 becoming larger as it progresses to the channel outflow region 22.

The connection assembly 1, after the establishment of the connection, has a connection block 2 with a high-pressure pipe 3 of aluminium inserted therein from the one side 18 and with a tapering hard metal nozzle 4 inserted into the through channel 16 from the other side 19 and pressed into the high-pressure pipe 3. That results in a cold deformation of the end region 23 of the high-pressure pipe 3 that enlarges the pipe diameter and substantially fills the gap 5.

The invention opens up the possibility that the connections of the high-pressure pipes can be produced quickly and easily.

It is therefore intended that the foregoing detailed description be regarded as illustrative rather than limiting, and that it be understood that it is the following claims, including all equivalents, that are intended to define the spirit and scope of this invention.

1. A connection assembly for the establishment of connections of high-pressure pipes in vehicle air conditioning units, the connection assembly comprising:
a connection block having portions defining a through channel, the through channel including a narrowing portion defined by at least one step that generally conically narrows the through channel progressing from a channel inflow region to a channel outflow region;
a nozzle located in the through channel of the connection block, the nozzle having portions defining a channel extending there through and having an tapering portion with an exterior surface including at least one step that generally conically tapers the nozzle along the tapering portion, the narrowing portion and the tapering portion generally corresponding with each other and cooperating to define stepped circular gap there between, the nozzle being made of a material having a first hardness and a first coefficient of thermal expansion;
a high-pressure pipe extending through the channel outflow region and having a cold deformation end region located in the stepped circular gap, the high-pressure pipe being made of a material having a second hardness and a second coefficient of thermal expansion;
whereby the nozzle is insertable into the connection block from the channel inflow region and the high-pressure pipe is insertable into the connection block from the channel outflow region, and by means of pressing of the nozzle into the high-pressure pipe the stepped circular gap is filled by cold deformation of the cold deformation end region of the high-pressure pipe; and
the first hardness of the nozzle being greater than the second hardness of the high-pressure pipe, and the first coefficient of thermal expansion of the nozzle being less than the second coefficient of thermal expansion of the high-pressure pipe.

2. The connection assembly of claim 1 wherein the cold deformation end region is formed in step-like partial zones and includes an axially directed sealing surface engaging the nozzle and a radially directed sealing region surface engaging the connection block.

3. The connection assembly of claim 1 wherein the connection block also including portions defining an annular groove in the channel inflow region and the nozzle includes a flange corresponding with the annular groove and being received therein, the narrowing portion being located to one side of the flange.

4. The connection assembly of claim 3 wherein when the flange engages a stop formed on the connection block adjacent to the annular groove.

5. The connection assembly of claim 1 wherein the at least one step of the nozzle and the at least one step of the connection block are located generally opposite of one another.

6. The connection assembly of claim 1 wherein the first hardness of the nozzle is at least 50% greater than the second hardness of the connection the high-pressure pipe.

7. The connection assembly of claim 1 wherein the tapering portion of the nozzle includes an alternating series of reduced diameter cylindrical outer surfaces and tapering truncated cone outer surfaces,

8. The connection assembly of claim 1 wherein the nozzle includes end face within the connection body that has a larger outer diameter compared to an inner diameter of the high-pressure pipe located in the channel outflow region.

9. The connection assembly of claim 1 wherein the narrowing portion of the through channel includes an alternating series of reduced diameter cylindrical inner surfaces and tapering truncated cone inner surfaces.

10. The connection assembly of claim 1 wherein the narrowing portion and the tapering portion have varying diameters such that the stepped circular gap varies in width over its length.

11. The connection assembly of claim 1 wherein the cold deformation end region of the high-pressure pipe has an inner replica surface of the nozzle and an outer replica surface of the through channel.

12. The connection assembly of claim 1 wherein the connection block is cuboid-shaped.

13. The connection assembly of claim 1 wherein the nozzle and high-pressure pipe are made of metal.

14. A method for establishment a connection for high-pressure pipes in vehicle air conditioning units, the method comprising the steps:
providing a connection block with a through channel having stepped narrowings;
positioning a high-pressure pipe within the stepped narrowing;
inserting a nozzle having a stepped tapering into the connection block;
pressing, with a nozzle end face leading, the nozzle into the high-pressure pipe;
cold-deformingly an end region of the pipe into a circular gap defined between the nozzle and the through channel;
whereby the high-pressure pipe end region forms a radially enlarged cold deformation zone between the connection block and the nozzle and the cold deformation zone fills the circular gap and creates temperature-dependent direction-related sealing connections between the nozzle, the high-pressure pipe and the connection block.

15. The method of claim 14 wherein in the cold deformation zone the axial sealing pressure P_{ax,0} parallel to the pipe axis at the axial sealing surface increases for rising temperatures T>T₀ over a predefined standard temperature T₀ and the accompanying radial sealing pressure, P_{rad,0}, in the radial sealing region is reduced, and for temperatures T<T₀ below the predefined standard temperature T₀ the radial sealing pressure, P_{rad,0}, directed vertical to the pipe axis increases in the radial sealing region and the axial sealing pressure P_{ax,0} at the axial sealing surface is reduced.

16. A connection assembly for the establishment of connections of high-pressure pipes in vehicle air conditioning units, the connection assembly comprising:
a connection block having portions defining a through channel, the through channel including a narrowing portion defined by at least one step that generally conically narrows the through channel progressing from a channel inflow region to a channel outflow region;
a nozzle located in the through channel of the connection block, the nozzle having portions defining a channel extending there through and having an tapering portion with an exterior surface including at least one step that generally conically tapers the nozzle along the tapering portion, the narrowing portion and the tapering portion generally corresponding with each other and cooperating to define stepped circular gap there between, the nozzle being made of a material having a first hardness and a first coefficient of thermal expansion;
the connection block being made of a material having a second hardness and a second coefficient of thermal expansion;
whereby the nozzle is insertable into the connection block from the channel inflow region and the high-pressure pipe is insertable into the connection block from the channel outflow region, and by means of pressing of the nozzle into the high-pressure pipe the stepped circular gap is filled by cold deformation of the end region of the high-pressure pipe; and
the first hardness of the nozzle being greater than the second hardness of the connection block, and the first coefficient of thermal expansion of the nozzle being less than the second coefficient of thermal expansion of the connection block.

17. The assembly of claim 16 wherein the stepped circular gap defines an inner diameter that is greater than an inner diameter of the channel of the nozzle.

18. The assembly of claim 16 wherein the stepped circular gap defines an outer diameter that is greater than a diameter defined by the channel outflow region.
